(19) United States
(12) Patent Application Publication
(10) Pub. No.: US 2013/0020181 A1
(43) Pub. Date: Jan. 24, 2013

(54) Elastic Spreading Belt

(71) Applicants: Benjamin Kallsen, Mohrkirch (DE); Oliver Carstensen, Hurup (DE)

(72) Inventors: Benjamin Kallsen, Mohrkirch (DE); Oliver Carstensen, Hurup (DE)

(73) Assignee: MARTENS TRANSPORTBANDER GMBH, Flensburg (DE)

(21) Appl. No.: 13/544,358

(22) Filed: Jul. 9, 2012

(30) Foreign Application Priority Data
Jul. 9, 2011 (DE) 20 2011 103 071

(51) Int. Cl. B65G 15/32

(52) U.S. Cl. 198/844.1

(57) ABSTRACT

An elastic spreading belt with an elastic fabric tape, a coating applied thereon, and perforated strips arranged in longitudinal direction on both sides thereof, into each of which a plate link chain engages, characterized in that the coating is made from polyurethane.

The invention relates to an elastic spreading belt provided with an elastic fabric tape.

Elastic spreading belts are used to keep separated a product, in particular a food product, after it has been deposited on a conveyor belt, for example, in order to further process or package said product.

These elastic spreading belts are provided with an elastic fabric tape, a coating applied thereon, and perforated strips arranged in longitudinal direction on both sides thereof, into each of which a plate link chain engages.

The elastic fabric tape is uniformly provided with a coating, which has a correspondingly elastic configuration, for which in particular silicone is used nowadays.

The use of silicone has the disadvantage, however, that its application is critical and special measures have to be taken against aging of the material.

It is an object of the invention to create an elastic spreading belt of the kind described initially, whose coating does not present any problems.

This object is attained according to the invention by making the coating from polyurethane.

The coating can be a polyurethane film laminated onto the fabric tape, but the coating can alternatively also be formed by a polyurethane solution sprayed onto the fabric tape or, however, by applying a polyurethane casting resin with a doctor knife onto the fabric tape.

The invention takes advantage of the fact that polyurethane is a non-toxic material, which is permanently elastic when applied in a sufficiently thin layer.

A lamination of a polyurethane film is one method for applying polyurethane on this fabric tape to be coated. A polyurethane solution can alternatively be sprayed onto the fabric tape, so that the coating is then made of polyurethane after the solvent escapes.

It is also possible to form the coating by applying polyurethane casting resin on the fabric tape with the aid of a doctor knife.

The coating can be provided on one or both sides (running and load-bearing side).

1. An elastic spreading belt with an elastic fabric tape, a coating applied thereon, and perforated strips arranged on both sides in longitudinal direction, into each of which a plate link chain engages,
characterized in that
the coating is made from polyurethane.

2. The elastic spreading belt of claim 1, characterized in that the coating is a polyurethane film laminated onto the fabric tape.

3. The elastic spreading belt of claim 1, characterized in that the coating is formed by means of a polyurethane solution that is sprayed onto the fabric tape.

4. The elastic spreading belt of claim 1, characterized in that the coating is formed by applying polyurethane casting resin onto the fabric tape with the aid of a doctor knife.
